(19) United States
(12) Patent Application Publication
(10) Pub. No.: US 2009/0263698 A1
(43) Pub. Date: Oct. 22, 2009

(54) FUEL CELL SYSTEM AND FUEL CELL

(75) Inventors: Shouji Sekino, Tokyo (JP); Hiroshi Kajitani, Tokyo (JP); Takashi Manako, Tokyo (JP); Hidekazu Kimura, Tokyo (JP); Kenji Kobayashi, Tokyo (JP); Suguru Watanabe, Tokyo (JP); Takanori Nishi, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: NEC CORPORATION, Tokyo (JP)

(21) Appl. No.: 12/090,624

(22) PCT Filed: Oct. 3, 2006
(86) PCT No.: PCT/JP2006/319746

§ 371 Date: Apr. 17, 2008

(30) Foreign Application Priority Data
Oct. 20, 2005 (JP) 2005-305980

(51) Int. Cl. H01M 8/10

(52) U.S. Cl. 429/30

(57) ABSTRACT

A fuel cell system which allows uniform fuel distribution to respective fuel cells, comprising: a plurality of fuel cells 5 each including an anode 2, a cathode 3 and an electrolyte membrane 4 disposed between the anode 2 and the cathode 3; and a fuel supply flow path 6 branched to supply fuel to each of the fuel cells 5. The sectional area of the fuel supply flow path in the downstream of each branch connection is narrower than that in the upstream. The above-described structure avoids the decrease in the fuel supply pressure due to the reduced sectional area in the downstream of the branch connection. Therefore, the fuel is supplied to the respective fuel cell with uniform pressure.

### TECHNICAL FIELD

The present invention relates to a fuel cell system, more particularly, to a fuel cell system in which a plurality of fuel cells are arranged in a planar stack structure.

### BACKGROUND ART

Fuel cells incorporating a membrane and electrode assembly, (hereafter referred to as the MEA) are known in the art in which an electrolyte membrane is supported between an anode and a cathode.

Among such fuel cells, a type of fuel cell which directly supplies the liquid fuel to the anode is referred to as the direct fuel cell. In the direct fuel cell, the supplied liquid fuel is decomposed on the catalyst supported on the anode to produce protons, electrons and intermediate products. The produced protons travel to the cathode through the electrolyte membrane. Also, the generated electrons travel through an external load to the cathode. On the cathode, the protons and the electrons react with oxygen in air to produce reaction products. This results in electric power generation.

For example, in a direct methanol fuel cell (hereafter, referred to as the DMFC), which uses methanol aqueous solution as the liquid fuel, the reaction represented by the following Reaction Formula 1 occurs on the anode, and the reaction represented by the following Reaction Formula 2 occurs on the cathode:

CH₃OH+H₂O→CO₂+6H⁺+6e⁻, (Reaction Formula 1)

and

6H⁺+6e⁻+ 3/2O₂→3H₂O. (Reaction Formula 2)

Solid polymer electrolyte fuel cells that use liquid fuel are now expected as power sources for various electronic devices, such as portable devices, due to the easiness of size and weight reduction. For example, a plurality of fuel cells may be connected for the use as a power source of a device requiring relatively high power output, such as a personal computer (PC) and the like, because of the low power output of a single MEA (hereafter, each minimum unit configuring a stack is referred to as the fuel cell). As a structure incorporating multiple fuel cells, there are known: a bipolar structure in which unit cells of fuel cells are stacked in the thickness direction of the cells; and a planar stack structure in which unit cells of fuel cells are arrayed in plane.

The planner stack structure is more advantageous for devices designed to fulfill the portability requirement, such as notebook PCs, due to the limitation of the thickness. For the planar stack structure, two types of systems are known for supplying fuel to each of the plurality of fuel cells: the serial flow system in which the fuel is supplied to the respective fuel cells in series, and the parallel flow system in which the fuel is supplied to the respective fuel cells through branches from the central flow path.

In the serial flow path system, the fuel having been used for electric power generation in the upstream cells is also used in the downstream cells, and therefore the downstream cells experience thin fuel concentration and high temperature. As a result, the electric power generation conditions may be largely different between the upstream fuel cells and the downstream fuel cells. Electric power generation with the same current in different electric power generation conditions may cause the downstream cells to be subjected to a severe electric power generation environment. This causes the downstream fuel cells to suffer from enhanced deterioration.

On the contrary, the parallel flow path system achieves uniform fuel distribution and thereby allows stable electric power generation, because of the ability of supplying the fuel to respective fuel cells with the same concentration and temperature.

However, the parallel flow path system requires branching and joining of the fuel in the supply flow path and in the return flow path. Since the inner pressure of the flow path changes at the branching points and joining points, it is difficult to uniformly distribute the fuel to the respective fuel cells. Additionally, the supply to the respective fuel cells may be off-balanced because of the local deviation in the pressure distribution, since the fuel circulating system and the like operates as a liquid-vapor mixture system due to the CO₂ produced by the electric power generation and introduced into the fuel cells and the return flow path.

Therefore, it is desired to provide a technique for uniformly distributing the fuel to the respective fuel cells for a planar stack type fuel cell system with the parallel flow path system. It is also desired to provide a technique for avoiding the CO₂ produced by the electric power generation being introduced into the fuel cells and the return flow path.

Various approaches have been proposed for uniformly distributing the fuel in the fuel cell system with multiple fuel cells. For example, in the fuel cell described in Japanese Laid Open Patent Application No. JP-A 2003-203647, an approach has been proposed in which grooves and holes are provided for a separator and the liquid fuel is supplied through these flow paths.

Also, in the fuel cell described in Japanese Laid Open Patent Application No. JP-A 2002-175817, an approach has been proposed in which a CO₂ exhaust groove is provided within the fuel cell to separate the exhausted CO₂ from the supplied fuel.

Japanese Laid Open Patent Application No. JP-A 2002-56856 discloses a fuel cell in which a fuel supply flow path and a CO₂ exhaust groove are formed on an interface between an electrolyte membrane and a catalyst layer.

Also, Japanese Patent Gazette No. 3442688 and Japanese Laid Open Patent Application No. JP-A 2001-15130 disclose a fuel cell configured to decrease the fuel vaporization through the MEA by supplying the liquid fuel to the anode after the evaporation through the fuel supply layer.

Also, Japanese Laid Open Patent Application No. JP-A 2001-102070 discloses a fuel cell characterized in comprising: an electrolyte membrane; fuel and oxidant electrodes opposed to each other across the electrolyte membrane; a fuel container for holding the liquid fuel on the fuel electrode surface; and a separation membrane formed in the fuel container to separate carbon dioxide gas and the liquid fuel and to selectively exhaust the carbon dioxide gas generated from the fuel electrode out of the fuel container.

Also, Japanese Laid Open Patent Application (JP-P 2003-317745A) discloses a direct methanol fuel cell pack of the spontaneous respiration type, which includes: an electrolyte membrane; a membrane electrode assembly (MEA) in which a large number of unit cells are formed with a large number of anode electrodes provided on a first plane of the electrolyte membrane, and with a large number of cathode electrodes provided on a second plane of the electrolyte membrane on the side opposite to the first plane to be associated with the respective anode electrodes; a fuel supply room storing therein the fuel to be supplied to the anode electrodes, and attached with a fuel supply plate through which a large number of fuel supply holes are formed to pass the inner fuel; and a wicking sheet provided in the shape of a fuel supply path between the fuel supply plate and the MEA to diffuse and supply the fuel to the anode electrodes of the MEA through the fuel supply plate.

Also, Japanese Laid Open Patent Application No. JP-A 2003-346862 discloses a fuel cell including: a positive electrode for reducing oxygen; a negative electrode for oxidizing a fuel; an electrolyte layer formed between the positive electrode and the negative electrode; and an exhaust port for exhausting the fuel and the substances generated when the fuel is oxidized, the fuel cell being characterized by at least one approach selected from a group consisting of: an approach in which a catalyst is provided for the exhaust port for oxidizing the substance generated by the imperfect fuel oxidation; and an approach in which an absorbent is provided for the exhaust port for absorbing the substance generated by the imperfect fuel oxidation.

Also, Japanese Laid Open Patent Application No. JP-A 2002-280016 discloses a fuel cell for smoothly exhausting the carbon dioxide, which is reaction by-product, through a gas exhaust path provided in a current collector.

Japanese Laid Open Patent Application No. JP-A 2001-283892 discloses a single electrode cell pack for a fuel cell that contains: cells each having a membrane arranged in a center portion, a cathode and anode which are arranged on the respective sides of the membrane; an electricity collector electrically connected with the cathode and the anode; and an electric connection member providing electrical connections among the cells, characterized in that the number of the cells is two or more, and the cells are commonly arranged on a specific flat surface across a cavity in which the electric connection member is arranged, wherein the single electrode cell pack is provided with: a porous fuel diffusion member provided in contact with the anode to allowing the fuel to be diffused into the cell; a porous fuel contact member provided in contact with the anode to bring the fuel and air into contact with each other inside the cell; anode and cathode end plates arranged on the anode side and the cathode side of the cell, respectively, in order to protect the cell; fuel supplying and exhausting means for supplying the fuel to the portion of the cavity on the anode side and exhausting the fuel; a fuel flow stop member for preventing the fuel circulating in the cavity on the anode side from flowing into the portion on the cathode side from the cavity, in the portion on the cathode side of the cavity; and a sealing portion for sealing an anode portion in which the anode is arranged in the cell, and the cavity corresponding to the anode portion, from outside.

Nevertheless, none of the above-mentioned patent documents describes a technique for uniformly distributing the fuel to the respective fuel cells. This requirement is desirably fulfilled with a simple structure in an aspect of avoiding the CO₂ produced by the electric power generation being introduced into the fuel cell and the return flow path. It is also desired to provide a technique for avoid the CO₂ being introduced into the fuel cell and the return flow path after a long-time operation of the fuel cell.

### DISCLOSURE OF INVENTION

An object of the present invention is to provide a fuel cell system and fuel cells which allow uniformly distributing the fuel to the respective fuel cells.

Another object of the present invention is to provide a fuel cell system and fuel cells for avoiding the CO₂ produced by the electric power generation being introduced the fuel cells and the return flow path.

Still another object of the present invention is to provide a fuel cell system and fuel cells for avoiding the CO₂ produced by the electric power generation being introduced into the fuel cell and the return flow path after a long-time operation of the fuel cells.

In order to address the above-mentioned objects, the fuel cell system according to the present invention is provided with: a plurality of fuel cells each including an anode, a cathode and an electrolyte membrane disposed between the anode and the cathode; and a fuel supply flow path branched to supply fuel to each of the fuel cells. The fuel supply flow path has at least one branch connection at each of which the sectional area in the downstream is narrower than that in the upstream.

The flow quantity of the fuel flowing through the flow path is decreased in the downstream of the branch connection. The decrease in the fuel flow quantity causes the decrease in the flow pressure in the downstream, when the sectional area of the fuel supply flow path is equal between the upstream and the downstream of the branch connection. The above-described structure, in which the sectional area of the flow path on the downstream of the branch connection is decreased, avoids the fuel flow pressure drop. This allows fuel supply to each fuel cell with a uniform pressure.

In this fuel cell system, the fuel cells are preferably arranged on a plate-shaped frame so as not to overlap each other. Each fuel cell has a fuel tank for accumulating the fuel supplied from the fuel supply flow path.

In this fuel cell system, the fuel tank preferably receives the fuel from the fuel supply flow path through an opening having a diameter of 0.1 to 1.0 mm.

Supplying the fuel to the fuel tank through the opening having a diameter of 0.1 to 1.0 mm in this way is preferable from the viewpoint that the fuel flows in only one direction to the fuel tank from the fuel supply flow path. The supply of the fuel to the fuel tank from the fuel supply flow path tends to be insufficient when the diameter of the opening is 0.1 mm or less. When the diameter of the opening is 1.0 mm or more, on the other hand, the flow of the fuel inside the fuel tank tends to be non-uniform.

In the above-described fuel cell system, the opening is preferably to be provided through the bottom face of the fuel tank. Providing the opening through the bottom face of the fuel tank promotes the one-way fuel flow from the fuel supply flow path to the fuel tank; this avoids the backflow from the fuel tank to the fuel supply flow path. The variation in the inner pressure of the fuel supply flow path is further suppressed by avoiding the backflow to the fuel supply flow path. As a result, the fuel is supplied to the respective fuel cells with more uniform pressures.

In this fuel cell system, a wicking member for holding the fuel is preferably inserted into the fuel tank. Here, the wicking member has a function of holding the fuel flowing into the fuel tank. The thus-described insertion of the wicking member disperses the flow direction of the fuel flowing into the fuel tank, thereby attaining the uniformity.

In this fuel cell system, each fuel cell preferably includes a fuel supply control membrane formed on the fuel tank which selectively transmits only gas component of the fuel to supply to the anode.

The provision of the fuel supply control membrane as mentioned above allows the fuel to be supplied to the anode with an optimal flow quantity.

In this fuel cell system, the wicking member is preferably inserted into the fuel tank so as not to cover the opening.

The wicking member provided so as not to cover the opening as mentioned above allows the fuel flowing into the fuel tank from the opening to mainly flow on the surface of the upper portion of the wicking member (the portion of the wicking member positioned near the fuel supply control membrane). Such structure allows the fuel to be stably supplied to the anode inside the fuel tank. This enhances selective supply of the liquid fuel to the surface portion of the wicking member, which is located near the anode, thereby promoting the vaporized fuel supply through the fuel supply control membrane.

Also, the wicking member is preferably formed of material which allows half or more of the fuel sent to the fuel tank to flow on the surface thereof without being absorbed by the wicking member; it is more preferable that the wicking member is formed of material which allows 70% or more of the fuel sent to the fuel tank to flow on the surface thereof.

The structure in which half or more of the fuel sent to the fuel tank flows on the surface of the wicking member helps to supply the fuel through the fuel supply control membrane to the anode. When the amount of the fuel flowing on the surface of the wicking member is half or less, on the other hand, the fuel is mainly held by the wicking member, making it difficult for the fuel to flow through the upper portion of the wicking member. That is, the fuel is difficult to be supplied through the fuel supply control membrane to the anode. The use of material as the wicking member which causes the increase in the flow path resistance after absorbing the fuel and thereby allows most of the supplied liquid fuel to flow on the surface of the wicking member determines the directivity of the fuel flow, achieving sufficient fuel supply to the anode 2 through the fuel supply control membrane even when the electric power generation is executed with a higher current condition.

In the fuel cell system according to the present invention, each fuel cell is preferably provided with an exhausting portion for exhausting the gas produced on the anode to the outside.

When CO₂ produced by the electrode reaction on the anode is exhausted to the outside, the CO₂ is not accumulated between the anode and the fuel supply control membrane. This avoids the supply of the vaporized fuel from the fuel supply control membrane to the anode being disturbed, since the pressure between the anode and the fuel supply membrane is not increased. Therefore, the fuel is stably supplied to the anode.

In this fuel cell system, it is preferable that each fuel cell includes a sealing member for sealing the side of the anode from the outside, and the exhausting portion is an exhausting path provided for the sealing member so as to exhaust the gas from the anode to the outside.

Such structure avoids the accumulation of CO₂ between the anode and the fuel supply control membrane, since the CO₂ produced by the electrode reaction on the anode is exhausted to the outside. The supply of the vaporized fuel from the fuel supply control membrane to the anode is not disturbed, since the pressure between the anode and the fuel supply membrane is not increased. As a result, the fuel is stably supplied to the anode.

In the fuel cell system according to the present invention, it is preferable that at least one penetrating hole is provided through the sealing member, and a hole is provided for a member disposed on the sealing member at the position corresponding to the penetrating hole, and that the exhaust portion allows the communication between an anode (2) and the outside through the penetrating hole and the hole.

Such structure avoids the accumulation of CO₂ between the anode and the fuel supply control membrane, exhausting the CO₂ produced by the electrode reaction on the anode to the outside. The supply of the vaporized fuel from the fuel supply control membrane to the anode is not disturbed, since the pressure between the anode and the fuel supply membrane is not increased. Therefore, the fuel is stably supplied to the anode. Additionally, the gas component is not introduced into the fuel circulating system, and this avoids the rapid variations in the fuel supply and in the flow path resistance inside the fuel cell, which are caused by the deposition of the CO₂ in the form of babbles on the surface of and inside the wicking member.

In the above-described fuel cell system, each fuel cell is preferably provided with: an evaporation suppression member arranged on the cathode and having a moisturizing property; and a meshed cover member arranged on the vaporization suppressing member. The movement of the protons produced on the anode to the cathode through the electrolyte membrane occurs under the existence of water. The vaporization suppressing member and the cover member suppress the vaporization of the water produced on the cathode in the electric power generation. This avoids the water vaporization from the electrolyte membrane (4).

The present invention provides a fuel cell system and fuel cells which allow uniform distribution of the fuel to the respective fuel cells.

Additionally, the present invention provides a fuel cell system and fuel cells which avoid CO₂ produced the electric power generation being introduced into the fuel cell and the return flow path.

Furthermore, the present invention provides a fuel cell system and fuel cells which avoid CO₂ produced the electric power generation being introduced into the fuel cell and the return flow path even after a long-time operation of the fuel cells.

### BRIEF DESCRIPTION OF DRAWINGS

FIG. 1 is a schematic view showing one example of the fuel flow path structure in a fuel cell system 1 according to the present invention;

FIG. 2 is a sectional view of the fuel cell structure on the B-B′ section shown in FIG. 1 of the fuel cell system 1 according to a first exemplary embodiment;

FIG. 3 is a perspective view depicting the structure of a fuel tank 8 within the fuel cell system 1 according to the first exemplary embodiment;

FIG. 4 is an exploded perspective view depicting the configuration of the portion positioned between an anode electric collector 24 and a cathode electric collector 25 in the fuel cell system 1 according to the first exemplary embodiment;

FIG. 5 is a sectional view of the fuel cell structure on the B-B′ section shown in FIG. 1 in the fuel cell system 1 according to a second exemplary embodiment;

FIG. 6 is a perspective view depicting the structure of the fuel tank 8 in the fuel cell system 1 according to the second exemplary embodiment;

FIG. 7 is an exploded perspective view depicting the configuration of the portion positioned between the anode electric collector 24 and the cathode electric collector 25 in the fuel cell system 1 according to the second exemplary embodiment;

FIG. 8A is a top view of a sealing member 15;

FIG. 8B is a top view of a sealing member 15;

FIG. 8C is a top view of a sealing member 15;

FIG. 8D is a top view of a sealing member 15;

FIG. 9 is an exploded perspective view depicting the configuration of the portion between the anode electric collector 24 and the cathode electric collector 25 in the fuel cell system 1 according to a third exemplary embodiment;

FIG. 10 is a sectional view of the fuel cell structure on the B-B′ section shown in FIG. 1 in the fuel cell system 1 according to the third exemplary embodiment;

FIG. 11 is a schematic view showing the flow path structure, with regard to the fuel cell systems 1 of Embodiment Examples 1 and 2;

FIG. 12 is a schematic view showing the flow path structure, with regard to the fuel cell systems 1 of Comparative Example 1;

FIG. 13 is measurement results of Embodiment Examples 1 and 2 and Comparative Example 1; and

FIG. 14 is measurement results of Embodiment Examples 1 and 2 and Comparative Example 1.

### BEST MODE FOR CARRYING OUT THE INVENTION

### First Exemplary Embodiment

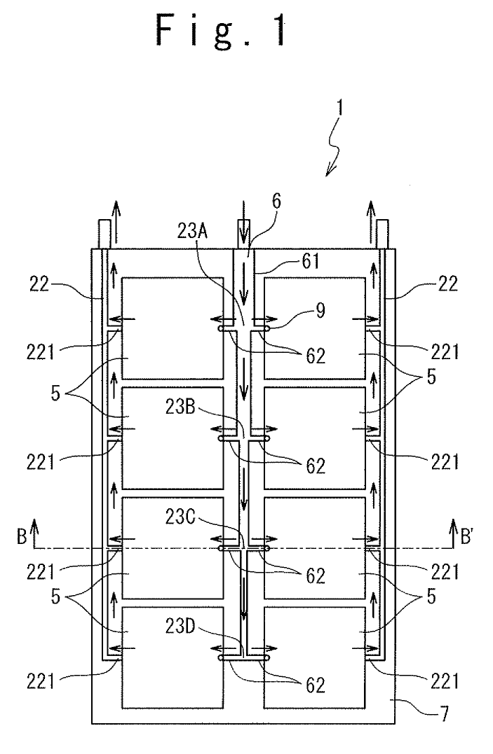

FIG. 1 is a top view of a fuel cell system 1 according to this exemplary embodiment. The fuel cell system 1 according to the present exemplary embodiment is provided with: a plurality of fuel cells 5 arranged on a plate-shaped frame 7 so as not to overlap with one another; a fuel supply flow path 6 provided within the frame 7; and return flow paths 22 provided within the frame 7 (Also shown in FIG. 1 are the fuel supply flow path 6 and the return flow paths 22, which are provided within the frame 7). Used as the fuel is methanol, which is a sort of liquid fuel.

The fuel supply flow path 6 is composed of a main flow path 61 and a plurality of branch flow paths 62 branched from the main flow path 61. Each branch flow path 62 is branched at the portion of at least one branch connection 23 from the main flow path 61 and connected to each fuel cell 5. In this exemplary embodiment, four branch connections 23 (branch connections 23A to 23D) are provided, and two branch flow paths 62 are branched from the main flow path 61 at each branch connection 23; each branch flow path 62 is connected to the fuel cell 5.

Here, at three upstream branch connections 23 (the branch connections 23A to 23C) out of the four branch connections, the sectional area of the flow path in the downstream is narrower than that in the upstream. That is, the main flow path 61 has a larger sectional area in the upstream of the branch connection 23A between the upstream and downstream of the branch connection 23A. Similarly, the sectional area in the upstream is larger than the downstream at the branch connections 23B and 23C. That is, the main flow path 61 has a narrower sectional area as it goes from the branch connections 23A to 22B, and to 22C. The sectional areas of the branch flow paths 62 are sufficiently narrowed, compared with the sectional area of the main flow path 61. It should be noted that, as to the branch connection 23D, the sectional area in the downstream is not always required to be narrower; however, it is more preferable that the sectional area in the downstream is also narrower at the branch connection 23D, similarly to the branch connections 23A to 23C.

The fuel that is not consumed in the respective fuel cells 5 are introduced into the return flow path 22 through return branch flow paths 221 connected to the respective fuel cells 5. The fuel cell system 1 of the present invention has a planar stack structure with a parallel fuel supply system for circulating the fuel with such routing.

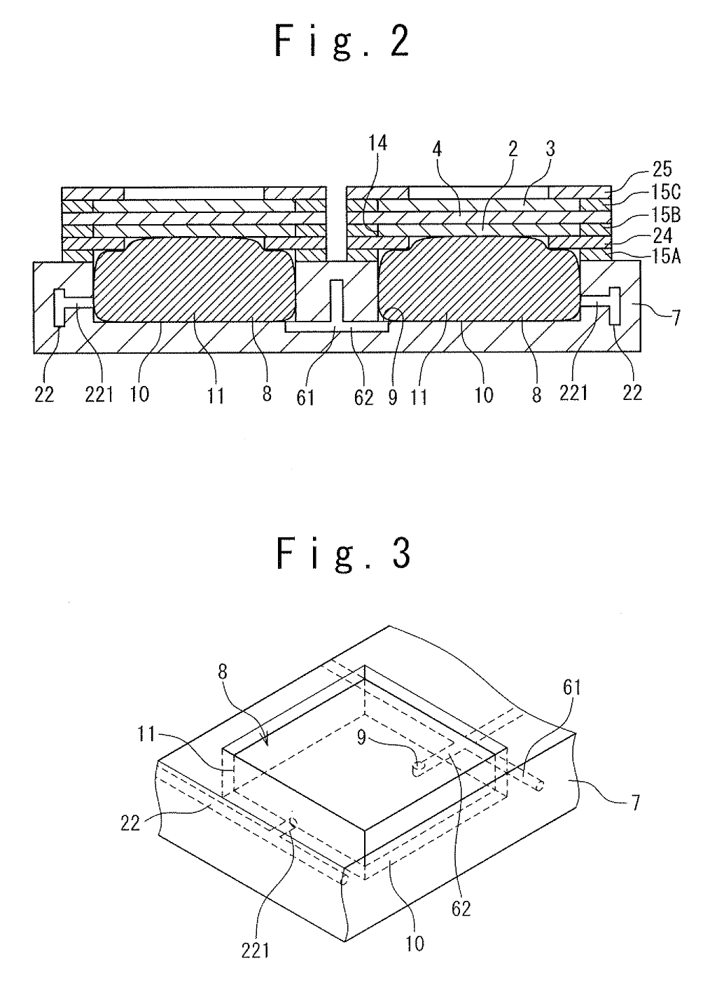

FIG. 2 shows a sectional view of the fuel cell system 1 on the B-B′ section of FIG. 1. Each fuel cell 5 is provided with a fuel tank 8 for holding the fuel received from the branch flow path 62 and an MEA arranged on the fuel tank 8. The MEAs are each composed of an electrolyte membrane 4 disposed between an anode 2 and a cathode 3. The MEAs are arranged such that the anodes 2 are placed to face the fuel tanks 8. Additionally, frame-shaped anode electric collectors 24 are arranged between the fuel tanks 8 and the MEAs. Arranged on the cathodes 3 of the MEAs are frame-shaped cathode electric collectors 25, similarly to the anode electric collectors 24.

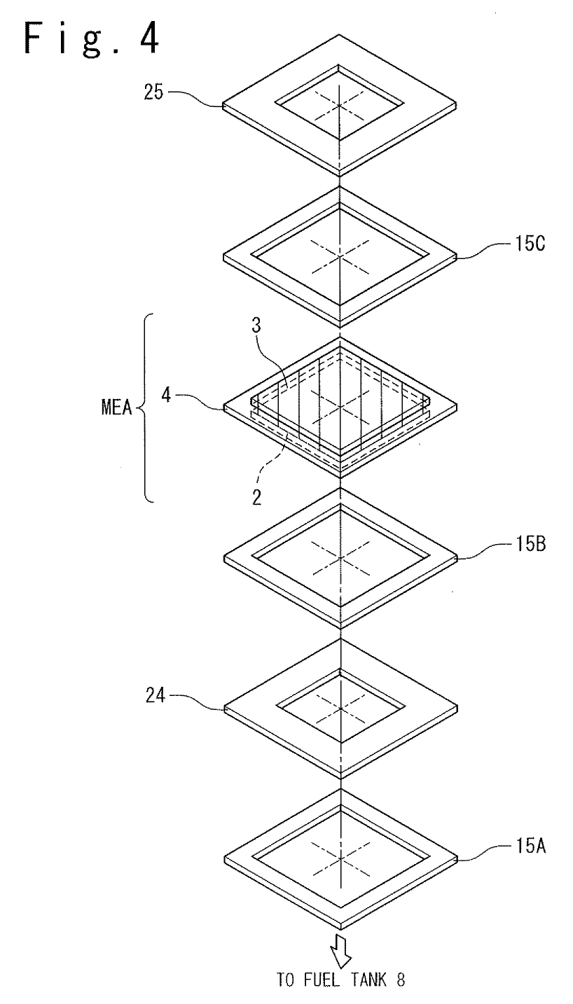

FIG. 4 is an exploded perspective view showing the structure of the portions where the anode electric collectors 24, the MEAs, and the cathode electric collectors 25 are provided. As shown in FIG. 4, the electrolyte membranes 4 are wider than the anodes 2 and the cathodes 4, and the edge portions thereof protrude from the portions supported between the anodes 2 and the cathodes 4. A plurality of frame-shaped sealing members 15 (15A to 15C) are additionally provided to seal the MEAs from the outside. The sealing members 15B are arranged on the side of the anode 2. Preferably, the thickness of the sealing members 15B are adjusted to the same thickness as that of the anodes 2 so as to avoid the formation of stepwise structure; this allows sealing the sides of the anodes 2 from the outside. The sealing members 15C are arranged on the side of the cathodes 3, similarly to the sealing members 15B. It is also preferable that the thickness of the sealing members 15C is adjusted to the same thickness as that of the cathodes 3; this allows sealing the sides of the cathodes 3 from the outside. Furthermore, the sealing members 15A are arranged below the anode electric collectors 24 (near the fuel tanks 8) to seal the gaps between the anode electric collectors 24 and the frame. The sealing members 15A may be provided with arbitrary thickness. It should be noted that the sealing members 15A are not always necessary when the anode electric collectors 24 is adhered closely to the frame 77, and the sealing members 15A may be omitted.

FIG. 3 is a perspective view showing the structure of the fuel tanks 8. As shown in FIG. 3, the fuel tanks 8 are concaves provided for the frame 7. Openings 9 are provided through the bottom faces 10 of the fuel tanks 8. The fuel tanks 8 communicate with the branch flow paths 62 through the openings 9. The openings 9 may be provided through the sides instead of the bottom faces 10; however, the provision through the bottom faces 10 is more preferable from the viewpoint of the backflow protection of the fuel. Preferably, the diameter of the openings 9 ranges from 0.1 to 1.0 mm. Adjusting the diameter of the openings 9 to this range increases the fuel supply pressure. The increase in the fuel supply pressure avoids the fuel backflow from the fuel tanks 12 to the fuel supply flow paths 21.

The fuel tanks 8 are connected to the return branch flow paths 221 on the opposite sides to the fuel supply flow paths 61 to exhaust the fuel from the fuel tanks 8 through the branch flow paths 221.

Wicking members 11 for holding the fuel are inserted into the fuel tanks 8. The wicking members 11 are intended to absorb and hold the liquid fuel, mainly by means of capillarity. The insertion of the wicking members 11 reduces the difference in the flow path resistance among the respective fuel cells 11, and thereby allows distributing the fuel more uniformly. Woven cloth, non-woven cloth, fibrous mats, fibrous webs, foamed plastic and the like may be used as the wicking members 11, for example, and hydrophilic material, such as hydrophilic urethane foam, and hydrophilic glass fiber, is preferably used in particular. For the use in the direct liquid fuel supply in which the anodes 2 are directly placed over the fuel tanks 8 to supply the liquid fuel to the anodes 2, as described in this exemplary embodiment, the flow path resistance is preferably reduced to the degree not to disturb the fuel flow. The use of material with reduced flow path resistance results in that the fuel is mainly absorbed into the wicking members 11 and uniformly supplied to the anodes 2 from the upper portions of the wicking members 11.

The fuel cells 5 of the present invention, incorporating the cell structures of the above-described configuration, are screwed and fixed onto the frame with a plurality of screws (not shown) penetrating the periphery portions of the cell structures. It should be noted that the technique for attaching the fuel cells 11 to the frame 10 is not limited to the screws; other techniques, such as adhesion, may be used instead as long as the structure avoids the liquid fuel being leaked from the fuel cells 11.

It should be noted that polymer films having high proton conductivity with no electron conductivity are preferably used as the electrolyte membranes 4 of the MEAs. Ion-exchange resin is suitable for the constituent material of the electrolyte membranes 4, which has a polar group, including a strong acid group such as a sulfonic group, a phosphoric group, a phosphine group, or a weak acid group such as a carboxyl group; specific examples are a perfluorosulfonic acid type resin, a sulfonated polyether sulfonic acid type resin, a sulfonated polyimide type resin. More specifically, the electrolyte membranes 4 may be solid polymer electrolyte membranes formed of aromatic series polymer such as sulfonated poly-(4-phenoxy benzoyl-1,4-phenylene), sulfonated polyether ether ketone, sulfonated polyether sulfone, sulfonated polysulfone, sulfonated polyimide, alkyl sulfonated polybenzimidazole. The film thickness of the electrolyte membrane 4 may be properly selected within the range between about 10 and 300 μm, depending on the material characteristics, the use field of the fuel cells and so on.

The cathodes 3 are electrodes that produce water by reducing the oxygen, as indicated by the Equation (2). For example, the cathodes 3 may be obtained by depositing a catalyst layer composed of: granules (including powder) that hold the catalyst on a carrier such as carbon or the catalyst single body without any carrier; and a proton conductor, on a substrate such as carbon paper, through coating or the like. The catalyst may be platinum, rhodium, palladium, iridium, osmium, ruthenium, rhenium, gold, silver, nickel, cobalt, molybdenum, lanthanum, strontium, yttrium and the like. The catalyst may be formed of one of materials listed above or a combination of two of the listed materials. The granules for carrying the catalyst are exemplified by carbon-based material, such as acetylene black, ketjen black, carbon nanotube, carbon nanohorn and so on. When the carbon-based material is particulate, for example, the size of the granules is properly selected within a range from about 0.01 to 0.1 μm, more preferably, within a range between about 0.02 and 0.06 μm. An impregnation method may be applied in order to make the granules carry the catalyst, for example.

Solid polymer electrolyte membranes may be used as the substrates on which the catalyst layers are formed; instead, conductive porous material may be used, such as carbon paper, carbon molded body, carbon sintered body, sintered metal, and foam metal. When substrates such as carbon paper are used, it is preferable that the catalyst layers are formed on the substrates to obtain the cathodes 31, and then the cathodes 31 are bonded to the solid polymer electrolyte membranes 33 with a method of a hot press or the like in a direction in which the catalyst layers are in contact with the solid polymer electrolyte membranes 33. The catalyst quantity of the cathodes 31 per unit area may be properly selected within a range between about 0.1 mg/cm² and 20 mg/cm², depending on the kind and size of the catalyst and so on.

The anodes 2 are electrodes which produce hydrogen ions, CO₂ and electrons from the methanol aqueous solution and the water, and the anodes 2 are configured similarly to the cathodes 3. The catalyst layers and substrates of the anodes 2 may be same as those of the cathode 3, or may be different instead. The catalyst quantity of the anodes 2 per unit area may be properly selected within a range between about 0.1 mg/cm² and 20 mg/cm², depending on the kind and size of the catalyst and so on, similarly to the case of the cathodes 3.

The cathode electric collectors 25 and the anode electric collectors 24 are arranged in contact with the cathodes 3 and the anodes 2, respectively, functioning so as to increase the electron extraction efficiency and the electron supply efficiency. In this exemplary embodiment, the electric collectors 24 and 25 are frame-shaped members provided in contact with peripheral portions of the anodes and the cathodes. The materials of the electric collectors 24 and 25 may be stainless steel, sintered metal, foam metal and the like, or members of the foregoing metal on which high conductive metal material is plated, or conductors such as carbon material, for example,

The sealing members (15A to 15C) preferably have the sealing property, the insulating property or the elastic property, depending on the necessity. The sealing members 15 may be formed of, for example, plastic material such as PTFE (polytetrafluoroethylene), PET (polyethylene terephthalate), PEEK (polyether ether ketone), and vinyl chloride, or rubber material such as fluorine resin, silicon rubber, and butyl rubber. The use of the sealing members 15 avoids the fuel being leaked from the fuel cells 5 to the outside.

A description is given of the fuel flow in the above-configured fuel cell system 1 in the following. As indicated by the arrows of FIG. 1, the fuel firstly flows through the fuel supply flow path 6. Then, the fuel branched at the branch connections 23 (23A to 23D) are supplied through the respective branch flow paths 62 to the respective fuel cells 5.

With reference to FIG. 2, the fuel flowing through the branch flow paths 62 is supplied from the openings 9 to the fuel tanks 8. The fuel flowing into the fuel tanks 8 is immersed into the wicking members 11 and held thereby. The fuel is then immersed out from the upper portions of the wicking members 11 and supplied to the anodes 2. The fuel supplied to the anodes 2 causes the reaction indicated by the following Equation 3 on the anodes, and also causes the reaction indicated by the following Equation 4 on the cathodes, achieving electric power generation.

CH₃OH+H₂O→CO₂+6H⁺+6e⁻, (Reaction Equation 3)

and

6H⁺+6e⁻+ 3/2O₂→3H₂O. (Reaction Equation 3)

The electric power generated on the anodes 2 and the cathodes 3 is taken out by the anode electric collectors 24 and the cathode electric collectors 25. On the other hand, the fuel that is not supplied to the anodes 2 is sent from the fuel tanks 8 through the return branch flow paths 221 to the return flow paths 22 and is exhausted in the direction of the arrows of FIG. 1.

As described above, the fuel cell system according to this exemplary embodiment reduces the inner pressure change inside the supply flow paths due to the structure in which the sectional area of the fuel flow path in the downstream of the branch connection is narrower than that in the upstream thereof. This achieves uniform supply pressures of the respective fuel cells regardless of the locations from the upstream and the downstream.

Additionally, only one-directional flow from the supply flow path to the fuel tanks is generated due to the fact that the fuel supply to the respective fuel cells 5 is achieved by ejecting the fuel through the narrow openings 9 of the diameter between about 0.1 and 1.0 mm from the bottoms of the fuel tanks 8. This reduces the generation of the backflow of the fuel, allowing the fuel to be supplied to the respective fuel cells with more uniform supply pressures.

As thus described, the liquid fuel with uniform concentrations is supplied in the uniform state to the respective fuel cells 5 arranged in parallel, and thereby the respective fuel cells 5 are made uniform in the electric power generation state, which enables the electric power generation in the more stable state for a long time.

### Second Exemplary Embodiment

### (Structure)

In the fuel cell system 1 in this exemplary embodiment, a plurality of fuel cells 5 are flatly arranged on the frame 7 similarly to the first exemplary embodiment. Improvements as compared with the first exemplary embodiment include: provision of fuel supply control membranes 12 formed between the fuel tanks 8 and the anodes 2; provision of cover members and vaporization suppressing members; provision of exhausting portions 13 for allowing the anodes 2 to communicate with the outside; and provision of penetrating holes through the wicking members. It should be noted that descriptions are omitted for the same portions as the first exemplary embodiment in the following.

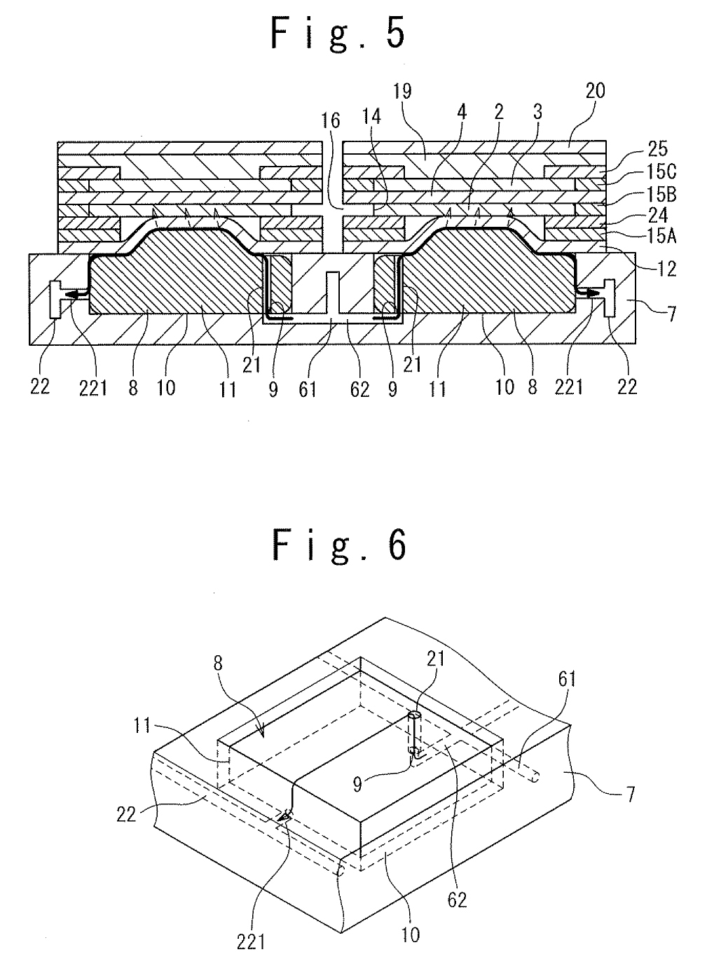

FIG. 5 is a sectional view showing the structure of the fuel cells 5 in the fuel cell system 1 according to this exemplary embodiment. In FIG. 5, the directions of the arrows indicate the directions in which the fuel easily flows. In each fuel cell 5, the fuel supply control membrane 12 is arranged on the fuel tank 8, which is the concave of the frame 7. The anodes 2 of the MEAs are arranged over the fuel supply control membranes 12 to face the fuel supply control membranes 12. The anode electric collectors 24 are arranged between the anodes 2 and the fuel supply control membranes 12. Additionally, the sealing members 15A are provided between the anode electric collectors 24 and the fuel supply control membranes 12. It should be noted that, although the anodes 2 are in contact with the fuel supply control membranes 12 on the center portions thereof in FIG. 5, gaps may exist therebetween. The electrolyte membranes 4 are formed on the anodes 2. The sealing members 15B are arranged on the sides 14 of the anodes 2, and the sides 14 of the anodes are protected from the outside. The cathodes 3 are provided on the electrolyte membranes 4. The frame-shaped cathode electric collectors 25 are arranged on the cathode 3. The sealing members 15C are also arranged on the sides of the cathodes 3, and the cathodes 3 are protected from the outside. Also, vaporization suppressing members 19 are provided to cover the cathodes 3 and the cathode electric collectors 25. Moreover, cover members 20 are provided on the vaporization suppressing members 19.

The fuel tanks 8 are provided as concaves of the frames 7, similarly to the first exemplary embodiment. FIG. 6 is a perspective view showing the structure of the fuel tanks 8. In FIG. 6, the direction of the arrow indicates the direction in which the fuel easily flows. The openings 9 are provided through the bottom faces 10 of the fuel tanks 8. The fuel tanks 8 are connected to the branch flow paths 62 branched from the main flow path 61 through the openings 9. The wicking members 11 are inserted into the fuel tanks B. Penetrating holes (hereafter, referred to as wicking holes 21) are provided through the wicking members 11 at the positions corresponding to the openings 9. That is, the openings 9 are not covered with the wicking members 11 due to the existence of the wicking holes 21.

It is preferable that material is used as the wicking members 11, which allows half or more of the fuel sent to the fuel tanks 8 to flow on the surface thereof without being absorbed by the wicking members 11. It is also preferable that the wicking members are filled in the fuel tanks 8 so as to eliminate the spacing therein. It is also preferable that the wicking holes 21 are provided only in the portions in contact with the openings 9, having a size equal to or slightly larger than the diameter of the openings 9. Such structure facilitates ejection of the fuel supplied from the openings 9 in the lateral direction of the anodes 2. As a result, the fuel is selectively sent toward the anodes 2. Also, the use of material which allows half or more of the fuel sent to the fuel tanks 8 to flow on the surface without being absorbed in the wicking member 11 results in that the fuel supplied from the bottoms is sent to the upper portions of the wicking members 11 and guided to flow on the upper surfaces of the wicking members 11, as indicated by the arrows in FIGS. 5 and 6. This enhances the effect of selectively sending the fuel to the anodes 2 through the fuel supply control membranes 12. In other words, only one-way fuel flow to the MEA is generated, thereby enabling more uniform distribution of the fuel to the respective fuel cells. This avoids the lack of the fuel supply to the anodes 2 in the high current condition, thereby keeping more uniform electric power generation state with high output. When the fuel flowing on the surfaces of the wicking members 11 is half or less of the fuel sent to the fuel tanks 8, on the other hand, this may cause the fuel to be mainly held by the wicking members 11, resulting in insufficient amount of the fuel supplied to the anodes 2 through the fuel supply control membranes 12.

It should be noted that it is preferable that the fuel supply control membranes 12 and the fuel tanks 8 are positioned closely to each other across gaps for flowing the liquid fuel therebetween, so that the liquid fuel flowing on the upper surfaces of the wicking members 11 and the liquid fuel once held by the wicking members 11 are directly supplied to the fuel supply control membranes 12 from the wicking members 11.

The fuel supply control membranes 12 are control membranes which allow selectively transmitting only the gas component of the liquid fuel. The fuel supply control membranes limit the supply amount of the fuel to the anodes 2. As a result, the optimal amount of the fuel is always supplied to the anodes 2 to maintain stable electric power generation.

The fuel supply control membranes 12 are fixed to the upper apertures of the fuel tanks 8, into which the wicking members 11 having the fuel holding ability are inserted. The fuel supply control membranes 12 are in contact with or positioned close to the electrodes configuring the anodes 2 by the pressure caused by the fuel supplied to the fuel tanks 8. Hydrophobic gas liquid separation membranes such as PTFE (polytetrafluoroethylene) porous body are mainly used as the fuel supply control membranes 12. The fuel supply amount to the fuel supply control membranes 12 is required at least to be equal to or greater than the consumption amount of the fuel in the MEAs. The fuel supply quantity to the fuel supply control membranes 12 is determined depending on: the properties resulting from the material characteristics of the fuel supply control membranes 12, such as the differences in the film thickness and the porosity; and the fuel transmission efficiency resulting from the external factors, such as the temperature and the humidity. It should be noted that the fuel supply control membranes 12 are not always required to be hydrophobic when exhausting portions 13 are additionally provided; and the hydrophilic porous membranes and the like may be used instead.

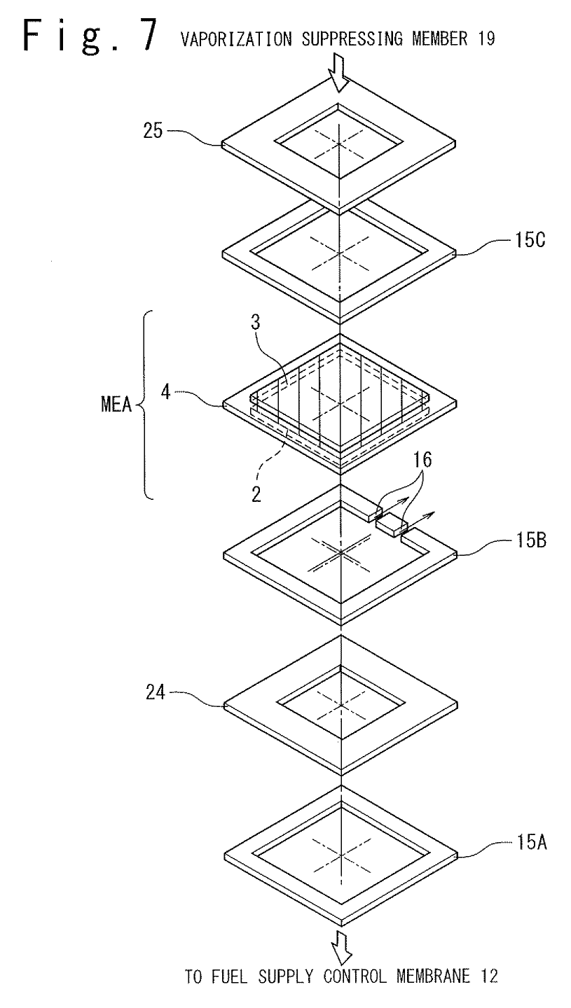

A description is then given of the exhausting portions 13 in the following. Each fuel cell 5 includes an exhausting portion 13 for exhausting CO₂ produced on the anode 2 to outside. FIG. 7 is an exploded perspective view illustrating the structures of the anode electric collectors 24, the MEAs and the cathode electric collectors 25 in the fuel cells 5. Similarly to the first exemplary embodiment, the sealing members 15B and 15C are provided to seal the sides of the anodes 2 and the cathodes 3. Also, the sealing members 15A are provided below the anode electric collectors 24. It should be noted that exhausting paths 16 are provided as the exhausting portions 13 through the sealing members 15B.

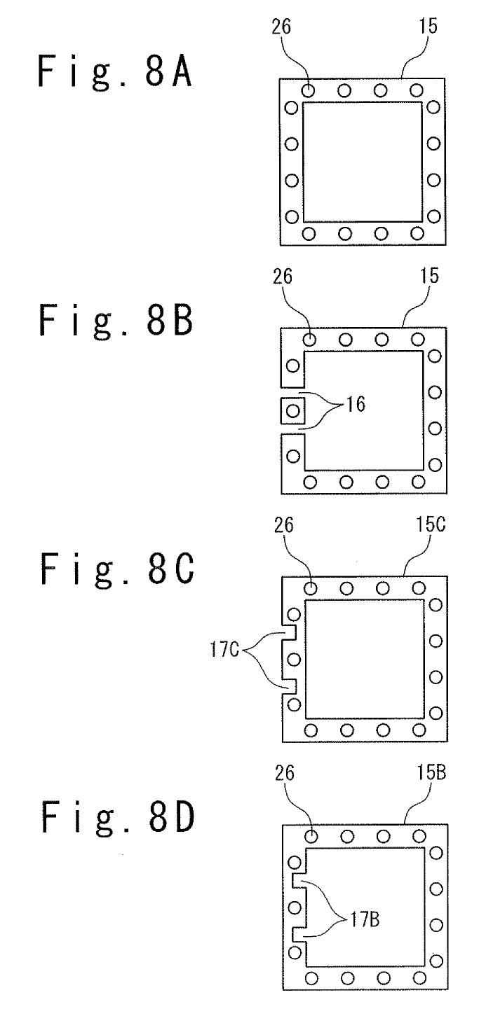

FIG. 8B is a top view of the sealing members 15B. Provided for at least one edge of the sealing members 15B are the exhausting paths 16. The exhausting paths 16 may be provided by forming the sealing members 15B as a combined structure of small piece members. In this case, the gaps between the members are used as the exhausting paths 16. It should be noted that the shape of the exhausting paths 16 are not limited to the above-described shape. Concaves or slits may be formed through the sealing member 15B, and the concaves may be used as the exhausting paths 16. As described above, the exhausting paths 16 allow exhausting CO₂ produced on the anodes 2 to the outside through the exhausting paths 16.

It should be noted that the sealing members 15A and 15B are structured without any gap as shown in FIG. 8A. Also, screw holes 26 are formed through the sealing members 15A, 15B and 15C. The sealing members 15 are fixed to the frame 7 with the screws inserted into the screw holes 26. It should be noted that the respective sealing members 15 preferably have the sealing property, the insulating property and/or the elastic property, depending on the necessary, and the sealing members 15 are usually made of rubber and plastic which have the sealing ability. The sealing members 15A and 15C are desired to have the sealing ability to avoid the fuel leakage and the like.

The sealing members 15 may be each made of plastic material such as PTFE (polytetrafluoroethylene), PET (polyethylene terephthalate), PEEK (polyether ether ketone), and the vinyl chloride; or rubber material such as fluorine resin, silicon rubber, and butyl rubber. The sealing members 15B are not always required to have the sealing ability, and therefore washer-shaped members or meshed members may be inserted as the spacers when structured to allow uniform electric collection.

The exhausting paths 16 may be formed for only one edge of the frames, or may be formed for two opposed edges, or may be formed for the four edges, while the shapes and arrangements thereof are not required to be equal among the respective fuel cells 5. Also, the number and size of the exhausting paths 16 are not especially limited; however, the number and size are preferably selected so that at least CO₂ is effectively exhausted.

A description is then given of the vaporization suppressing members 19 in the following with reference to FIG. 5. The vaporization suppressing members 19 are arranged on the cathodes 3 and the cathode electric collectors 25 so as to cover the cathodes 3 and the cathode electric collectors 25. As for a planar type fuel cell system, such as the fuel cell system of this exemplary embodiment, the whole structure is typically enclosed by a housing, and this may necessitate forced air blow toward the cathodes 3. When the fuel supply control membranes 12 are provided near the anodes 2, the electrolyte membranes 4 are not in direct contact with the liquid fuel, and this results in the decrease in the water concentration of the electrolyte membranes 4. Moreover, when the sides of the cathodes 4 are subjected to air blow, the water concentration of the cathodes 4 is also extremely decreased. The vaporization suppressing members 19 are provided in order to suppress the water vaporization caused by the air blow mentioned above and to thereby maintain the humidity condition suitable for the electric power generation.

The vaporization suppressing members 19 are members having the moisturizing property, for which member cellulose fiber and the like are used as raw materials. Hydrophilic materials such as woven cloth, non-woven cloth, fibrous mats, fibrous webs, and cellular plastic are exemplified as the vaporization suppressing member 19. It should be noted that the introduction of air necessary for the electric power generation can be enhanced by using the structure in which the air is introduced from the sides of the covers, or the structure in which holes are provided through the vaporization suppressing member 19, when the vaporization suppressing members 19 are used as the covers; however, the mechanism for enhancing the air introduction is not always necessary, since the vaporization suppressing members 19 themselves have the air permeability. Preferably, the vaporization suppressing members 19 and the cathodes 4 are in contact with each other; desirably-structured supporting members or spacers may be used to separate the cathodes 4 from the vaporization suppressing members 19.

The cover members 20 are provided to cover the vaporization suppressing members 19. Holed plates or meshed members of metal or plastic are suitably used as the cover members 20; for example, punching sheets of SUS having a surface coated with insulating paint are preferably used. When the cover members 19 are used, the vaporization suppression layers may be omitted under the small current and weak ventilation conditions, since the cover members 19 themselves have the effect of suppressing the waver vaporization; however, the insertion of the vaporization suppressing layers 51 is necessary when the electric power generation is executed under the high current density conditions of 100 A/cm² or more or the strong air blow conditions. With regard to openings of the cover members 20, small circular holes and the like are desirably provided such that the opening ratio ranges between about 5 and 50%.

In this exemplary embodiment, the following advantageous effects are achieved in addition to the advantageous effects of the first exemplary embodiment:

The fuel supply with the fuel supply control membranes 12, as in the fuel cell system 1 according to this exemplary embodiment, potentially causes poor fuel circulation, due to the insertion of the wicking members 11 into the fuel cells, which causes the increase in the flow path resistance for the liquid holding; however, the structure for ejecting the fuel from the wicking holes 21 towards the anodes 2 through the openings 9 provided for the bottom faces 10 of the fuel tanks 8 enhances the selective fuel flow on the surfaces of the wicking members 11, which are opposed to the anodes 2. As a result, the fuel is rather efficiently supplied to the anodes 2. Moreover, this suppresses the unbalance among the inner pressures of the respective fuel cells 5 caused by the accumulation of CO₂ inside the fuel cells 5, and the backflow of the CO₂ and fuel to the fuel supply flow path 6 caused by the increase in the inner pressures.

The CO₂ produced on the anodes 2 during the electric power generation is exhausted outside the fuel cells 5 from the exhausting paths 16 provided for the sealing members 15B through the gaps formed through the electrodes configuring the anodes 2 or between the anodes 2 and the fuel supply control membranes 12. Such CO₂ exhaustion mechanism allows the CO₂ to be exhausted from the neighbor of the anodes 2 while the fuel is vaporously supplied to the anodes 2. This avoids the CO₂ produced on the anodes 2 staying between the anodes 2 and the fuel supply control membranes 12.

Additionally, the exhaustion of the CO₂ to the outside from the exhausting paths 16 formed through the sealing members 15B prevents the pressure of the regions between the anodes 2 and the fuel supply control membranes 12 from exceeding the pressure of the regions between the fuel tanks 8 and the fuel supply control membranes 12. This avoids the gas flow from the anodes 2 to the fuel tanks 8 through the fuel supply control membranes 12, allowing the sufficiently higher fuel supply pressure of the anodes 2. As a result, the reaction efficiency on the anodes 2 is increased, while stable electric power generation is achieved for a long time even under the high current conditions.

Also, the fuel is uniformly distributed to the respective fuel cells 5 irrespectively of the use of the parallel flow path structure, since the variations in the supply pressure caused by the back pressure distribution generated in the return flow path 22 in association with the CO₂ generation are also reduced.

Moreover, the present exemplary embodiment does not require complex structure; the structure can be extensively simplified. Additionally, the present exemplary embodiment is superior in cost and safety, since the leakage of the liquid fuel is avoided by the fuel supply control membranes 12. In addition, the fuel vaporization through the electrolyte membranes 4 and the cathodes 3 is suppressed by the vaporization suppressing members 19 and the cover members 20, and therefore the fuel is not wastefully consumed as compared with the structure in which the liquid fuel is directly supplied; this results in the increase in the electric power generation efficiency.

Furthermore, the present exemplary embodiment decreases the water vaporization from the cathodes and thereby achieves the optimal humidity condition for the electric power generation, since the surfaces of the cathodes 3 are covered by the vaporization suppressing members 19 made of moisturizing material, and the cover members 20 formed of the holed plates made of metal and the like on the vaporization suppressing members 19. As a result, the wasteful vaporization of the fuel is reduced, thereby improving the electric power generation efficiency.

### Third Exemplary Embodiment

A description is given of a fuel cell system 1 according to the third exemplary embodiment of the present invention in the following. The fuel cell system 1 of this exemplary embodiment differs from that of the second exemplary embodiment in the structure of the exhausting portions 13. It should be noted that the portions other than the exhausting portions 13 are similar to those in the second exemplary embodiment, and therefore the explanations thereof are omitted.

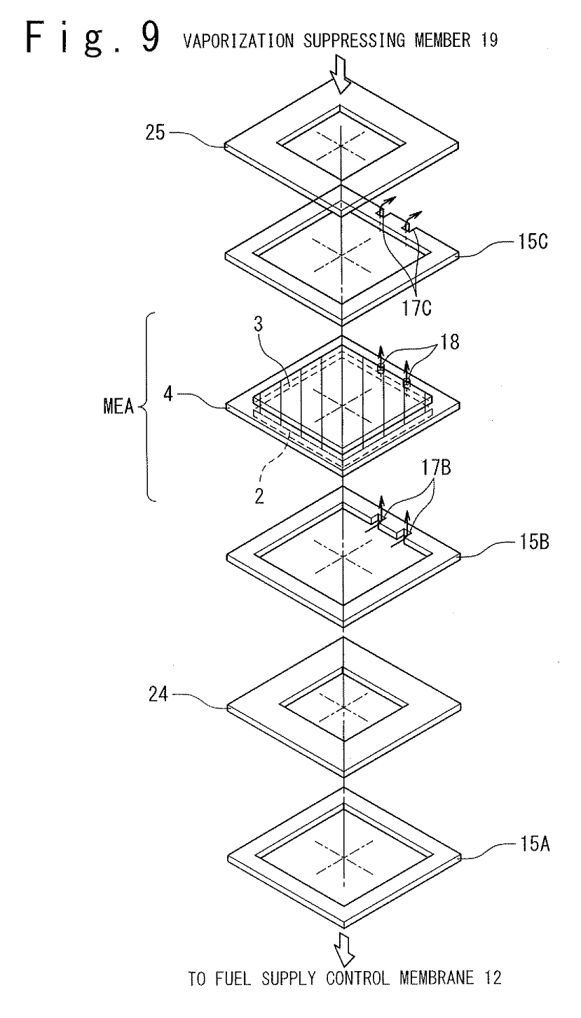

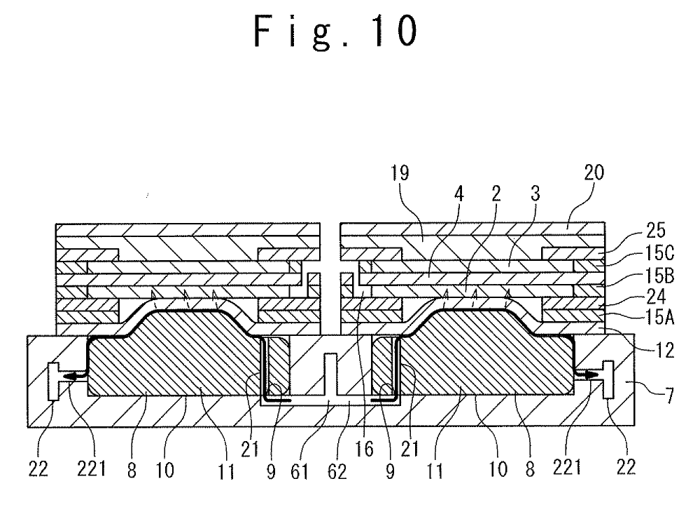

FIG. 9 is an exploded perspective view depicting the stack structure of the MEAs, the anode electric collectors and the cathode electric collectors 25 in the fuel cell system 1 according to this exemplary embodiment. In FIG. 9, the arrow direction indicates the direction in which the CO₂ is exhausted. The sealing members 15A to 15C are arranged similarly to the second exemplary embodiment. FIG. 8C is a plan view of the sealing members 15C, and FIG. 8D is a plan view of the sealing members 15B. As shown in FIG. 5D, two notches 17B extending inward are provided for the sealing members 15B. On the other hand, as shown in FIG. 50, notches 17C extending outward are provided for the sealing members 15C. Additionally, as shown in FIG. 9, holes 18 are provided through the electrolyte membranes 4 on the notches 17C. FIG. 10 is a sectional view depicting the stack structure from the anode electric collectors 24 to the cover members 20. The exhausting paths 16 are composed of the above-mentioned notches of the sealing members 15B, 15C and holes provided through the electrolyte membranes 4′ Through these exhausting paths 16, the anodes 2 communicate with the outside. It should be noted that the holes 18 provided through the electrolyte membranes are preferably have a diameter between about 0.3 and 2.0 mm. The diameter in this range allows effective exhaustion of CO₂.

The present exemplary embodiment offers the following advantageous effect in addition to the advantageous effects in the second exemplary embodiment:

In this exemplary embodiment, the CO₂ produced on the anodes 2 is exhausted from the anodes 2 to the outside through the notches 17B, the holes 18 and the notches 17C. This avoids accumulation of the CO₂ in the fuel cells 5, preventing the gas from being introduced into the fuel circulating system.

In the following, a specific description is given of the fuel cell system of the present invention, depicting examples.

### Embodiment Example 1

The structure of the fuel cell used in Embodiment Example 1 is described below. At first, the catalyst-carrying carbon granules were prepared, which are composed of carbon granules (Ketjen Black EC600JD manufactured by Lion Corporation) carrying platinum micro granules having a granule diameter in a range from 3 to 5 nm with the weight ratio of 50%, and catalyst paste for cathode formation was obtained by adding 5 weight % Nafion solution manufactured by E.I. du Pont de Nemours and Company (Article Name; DE521, “Nafion” is the registered trademark of E.I. du Pont de Nemours and Company) to 1 g of the catalyst-carrying carbon granules, followed by agitation. Cathodes 3 of 4 cm×4 cm are then formed through coating this catalyst paste on carbon paper (TGP-H-120 manufactured by Toray Industries, Inc.) as substrates with the coating quantity of 1 to 8 mg/cm², followed by drying. Anodes 2 were also prepared similarly to the cathodes. It should be noted, however, that platinum (Pt)-ruthenium (Ru) alloy granules (the Ru concentration is 50 at %) having a granule diameter in a range from 3 to 5 nm were used instead of the platinum granules for the preparation of anodes 2.

Membranes of 8 cm×8 cm with a thickness of 180 μm made of Nafion 117 (the number average molecular weight thereof is 250000) manufacture by E.I. du Pont de Nemours and Company were then prepared as the electrolyte membranes 4. The cathodes 3 were each arranged on one face facing the thickness direction of the electrolyte membrane 4, in the direction in which the carbon paper was positioned outward. The anodes 2 were each arranged on the other face in the direction in which the carbon paper was positioned outward. This was followed by hot pressing from the outer sides of the respective sheets of carbon paper. Consequently, the cathodes 3 and the anodes 2 were bonded to the electrolyte membranes 4 to complete MEAs (Membrane Electrode Assembly).

This was followed by placing anode electric collectors 24 and cathode electric collectors 25 on the cathodes 3 and the anodes 2, each of which collectors was formed of a rectangular frame plate of stainless steel (SUS316) of a thickness 200 μm, having an outer dimension of 6 cm², a thickness of 1 mm, and a width of 11 mm. Also, rectangular silicon rubber frames having an outer dimension of 6 cm², a thickness of 0.3 mm and a width of 10 mm were arranged between the electrolyte membranes 4 and the anode electric collectors 24 to function as the sealing member 15B. Here, two notches of a width of 0.5 mm were provided as the exhausting paths 16 for each frame edge of the sealing members 15B. As for other sealing members 15, arranged were sealing members 15A and 15C each formed of a rectangular frame plate of silicon rubber having an outer dimension of 6 cm², a thickness of 0.3 mm, and a width of 10 mm.

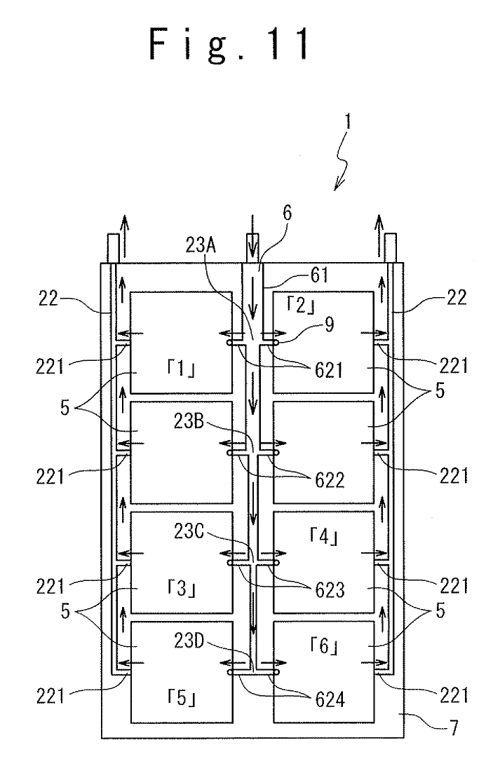

A frame of PP (poly propylene) having an outer dimension of 15 cm×30 cm with a thickness of 1 cm was used as the frame 7 of the fuel cell system 1, and eight concaves were formed as the fuel tanks 8 so as to accommodate fuel cells 1 in two columns and four rows within the frame 7 (See FIG. 11). Provided at the center of the frame 7 was a main flow path 61 of the fuel supply flow path 6 which communicated with the respective fuel tanks 8 through branch flow paths 621 to 624. It should be noted that the branch connections 23 are denoted by symbols A to D attached thereto for identification. The main flow path 61 was sequentially decreased in the sectional area to 20 mm², 15 mm² and 10 mm² as the fuel is branched to the branch flow paths 621 (provided at the branch connection 23A), to the branch flow paths 622 (provided at the branch connection 23B) and to the branch flow paths 633 (provided at the branch connection 23C). It should be noted that the sectional area of the main flow path 61 from the inlet to the branch connection 23A was adjusted to 25 mm². The size of the fuel tanks 8 was adjusted to have a height of 8 mm, an aperture of 4×4 mm and a depth of 3 mm. The openings 9 for the fuel supply were provided through the bottom faces to communicate with the branch flow paths 621 to 624. The wicking members 11 of urethane material serving as fuel holding material were inserted into the fuel tanks 8. Also, the fuel tanks 8 were connected to communicate with the two return flow paths 22 through the return branch flow path 221.

The MEAs, the cathode electric collectors 25, the anode electric collectors 24, the fuel supply control membranes 12 and the sealing members 15 (15A to 15C) were screwed with a predetermined number of the screws and integrated to complete fuel cells 11 of Embodiment Example 1.

Eight fuel cells 11 prepared as mentioned above were arrayed and fixed to the frame 7, which has the fuel flow path structure shown in FIG. 11. The adjacent cells were all connected electrically in series through the electric collectors. In FIG. 11, a negative terminal was drawn from the fuel cell at the position denoted by the symbol “5”, and a positive terminal was drawn from the fuel cell at the position denoted by the symbol “6”.

### Embodiment Example 2

A description is given of the structure of the fuel cells used in Embodiment Example 2 in the following. The manufacturing method and structure of the MEAs are similar to those of Embodiment Example 1. The flow path structure of Embodiment Example 2 was identically structured to Embodiment Example 1 (See FIG. 11). That is, the fuel supply flow path was decreased in the sectional area in the downstream as it passed through the branch connections.

Added to Embodiment Example 2 were fuel supply control membranes 12. Used as the fuel supply control membrane 12 were PTFE porous membranes of 8 cm×8 cm with a thickness of 50 μm (having a porous diameter of 1.0 μm and a porous ratio of 80%). Additionally, cotton fiber mats of 4 cm×4 cm were placed as the vaporization suppressing members 19 (the moisturizing layers) on the cathodes 3, and punching sheets of SUS having a thickness of 0.5 mm, a hole diameter of 0.75 mm and an opening ratio of 20% were placed as the cover members 20 thereon to fix the vaporization suppressing members 19.

The fuel cells 5 of Embodiment Example 2 were formed as a structure in which the MEAs, the cathode electric collectors 25, the anode electric collectors 24, the fuel supply control membranes 12, the sealing members 15, and the sealing members 15B with the exhausting paths 16 were screwed with a predetermined number of the screws to be integrated, and the vaporization suppressing members 19 and the cover members 20 were attached thereto. The wicking members 11 of the urethane material were inserted as the fuel holding material into the fuel tanks 8. Here, used as the urethane material was a type of material designed to increase the flow path resistance by fluid replacement, allowing the fuel to flow more easily on the surface than inside the wicking members 11. Additionally, semicircular small holes having a diameter of 0.7 mm were provided at the upper portions corresponding to the openings 9 of the wicking members 11, used as the wicking holes 21. It should be noted that the fuel cells 5 were structured as shown in FIG. 5. Similarly to Embodiment Example 1, adjacent cells were all electrically connected in series by the electric collectors. In FIG. 11, the negative terminal was drawn from the fuel cell at the position denoted by the symbol “5”, and the positive terminal was drawn from the fuel cell at the position denoted by the symbol “6”.

### Comparative Example 1

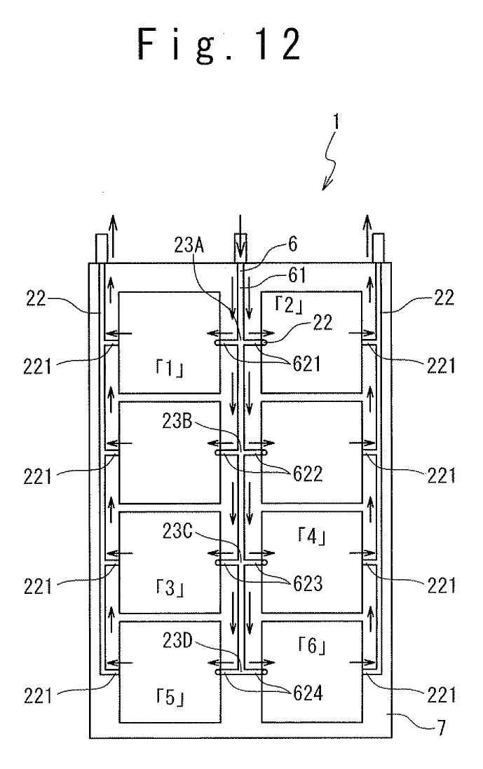

A description is given of the structure of the fuel cell used in Comparison Example 1 in the following. The manufacturing method and structure of the MEAs are similar to that of Embodiment Example 1. The flow path structure was structured so that the fuel was branched into the respective electric power generators from the main flow path 61 of the fuel supply flow path 6 positioned at the center and sent to the return flow paths 22 on the both ends, as shown in FIG. 12. Differently from Embodiment Examples 1 and 2, the main flow path 61 had a constant sectional area of 20 mm² between the fuel branch flow paths 621 and 624. The structure of the fuel cells 5 within the respective electric power generators were structured as shown in FIG. 5, and relatively rough urethane foam having a low flow path resistance was inserted as the wicking members 11. Adjacent cells were all electrically connected in series by the electric collectors. In FIG. 12, a negative terminal was drawn from the fuel cell at the position denoted by the symbol “5”, and a positive terminal was drawn from the fuel cell at the position denoted by the symbol “6”.

### (Experimental Result)

FIG. 13 shows the surface temperatures and the voltages of the cathodes 2 of the fuel cell systems of Embodiment Examples 1 and 2 and Comparison Example 1, obtained by implementing an electric power generation test for 30 minutes under the conditions in which 200 mL of 10 vol % methanol aqueous solution is circulated and supplied with a flow velocity of 10 mL/min in an atmosphere environment of a temperature of 25° C. and a humidity of 50% with a current level corresponding to the current density of 100 mA/cm². In the actual experiment, only the fuel cells 5 denoted by the numerals in FIG. 13 were monitored.

A portion of Comparison Example 1 experiences low voltage and the cathode surface temperature in this portion is higher by 10° C. or more as compared with other portions, due to the difficulty in supplying the fuel to a specific particular fuel cell 5. When the sectional area of the fuel supply flow path 6 is constant, the inner pressure is decreased as the fuel is branched, and therefore the inner pressure of the fuel supply flow path 6 is not sufficiently high as compared with the inner pressure of the fuel tanks 8, which is increased by the CO₂ produced by electric power generation, at the stage at which the fuel arrives at the branch flow paths in the downstream of the fuel supply flow path 6. This prohibits the smooth flow of the fuel due to the decreased fuel supply pressure to the fuel tanks 8. Additionally, the unsmooth supply of the fuel to the fuel cell 5 hinders the cooling of the MEAs by the fuel, and causes high temperatures of the MEAs within the fuel cells 5 when the current is continuously and forcedly drawn in such conditions; this causes control difficulty. Such portion in which the fuel supply is insufficient does not always exhibit only in the fuel cells 5 at the most downstream portion; such portion may exhibit even in the fuel cells 5 at the upstream portion or the middle portion, depending on the CO₂ production state and exhaustion system from the fuel tanks 8.

On the other hand, the backflow of the fuel to the fuel supply flow path 6 is suppressed in Embodiment Example 1, since the inner pressure drop in the fuel supply flow path 6 caused by the fuel branching is reduced by the structure in which the sectional area of the fuel supply flow path 6 is sequentially narrowed, and since the fuel supply pressure to the fuel tanks 8 is increased by the reduced aperture of the openings 9. This achieves uniform fuel supply to the respective fuel cells 5, resulting in the reduction in the cathode surface temperature of the MEAs down to about 7° C. at a maximum and also the reduction in the voltage distribution. It should be noted, however, that Embodiment Example 1 may cause local and/or temporal variations in the electric power generation state, since the inner pressure increase in the fuel tanks 8 caused by the CO₂ produced in the electric power generation is not improved.

Furthermore, Embodiment Example 2, which employs the approach in which the fuel is vaporously supplied from the fuel supply control membranes 12 and the CO₂ produced in the electric power generation is exhausted from the exhausting portions 13 provided through the sealing members 15B, allows substantially no CO₂ to be introduced into the fuel tanks 8 and the return flow paths 22, reducing the variations in the fuel supply pressure to the respective fuel cells 5 due to the back pressure caused by the CO₂ production and the voltage distribution of the respective fuel cells 5, while making the surface temperature of the cathodes 3 approximately uniform.

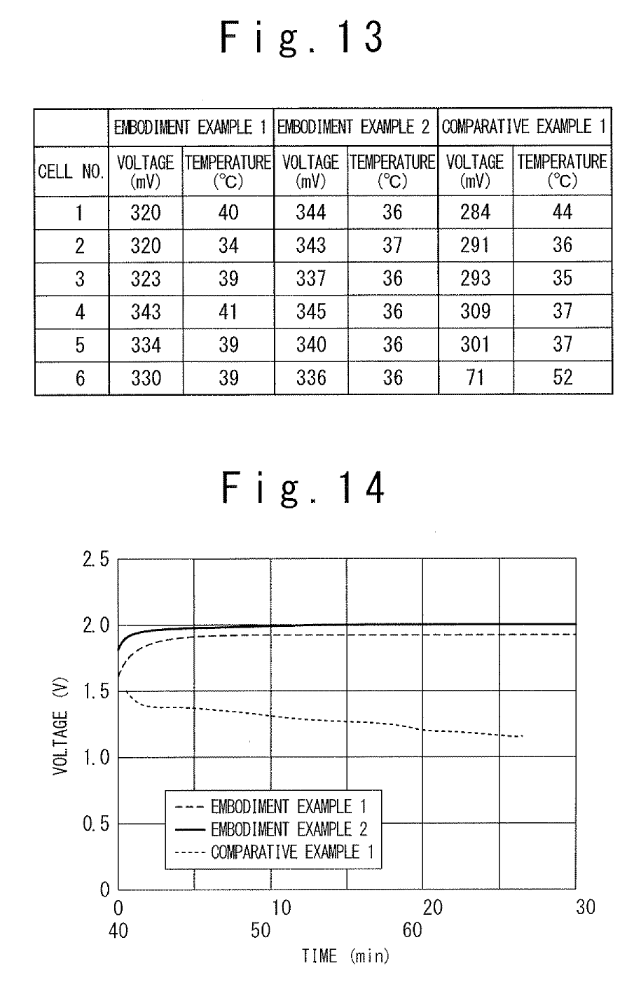

FIG. 14 shows temporal changes of the voltages for Embodiment Examples 1 and 2 and Comparative Example 1, when the electric power generation is executed for about 60 minutes under the same conditions as the above-described experiment. Comparative Example 1 exhibits a low original voltage, and suffers from a decrease in the voltage with time. On the contrary, Embodiment Example 1 stably achieves a high voltage, and does not exhibit a tendency of the voltage decrease with time. Furthermore, Embodiment Example 2 stably achieves a higher voltage, and never exhibit a tendency of the voltage decreased with time.

As thus described, the use of the approaches of the present invention exemplified by Embodiment Examples 1 and 2 improves the respective pressure balances in the fuel supply flow path 6, the return flow paths 22 and the fuel tanks 8, which have been a problem for the parallel fuel flow path structure, consequently achieving supplying the fuel with uniform concentration to the respective fuel cells 5 under the substantially same conditions. This consequently achieves uniform electric power generation states in the respective fuel cells 5 and long-time stabilization of the electric power generation over the entire fuel cell system 1.

1. A fuel cell system comprising:
a plurality of fuel cells including an anode, a cathode and an electrolyte membrane disposed between said anode and said cathode; and
a fuel supply path branched to supply fuel to each of said plurality of fuel cells,
wherein said fuel supply path is disposed so that a sectional area thereof in the downstream of a branch connection is narrower than that in the upstream.

2. The fuel cell system according to claim 1, wherein said plurality of fuel cells are arranged on the same plane.

3. The fuel cell system according to claim 1, wherein said plurality of fuel cells each includes a fuel tank having an aperture on a top thereof,
wherein said anode is positioned over the aperture of said fuel tank, and
wherein said fuel tank is connected to communicate with said fuel supply path.

4. The fuel cell system according to claim 3, wherein said fuel tank receives fuel from said fuel supply path through an opening having a diameter of 0.1 to 1.0 mm.

5. The fuel cell system according to claim 4, wherein said opening is provided through a bottom face of said fuel tank.

6. The fuel cell system according to claim 3, wherein wicking material for holding fuel is inserted into said fuel tank.

7. The fuel cell system according to claim 6, wherein each of said plurality of fuel cells including a fuel supply control membrane which selectively allows gas component of fuel to transmit therethrough, and
wherein said fuel supply control membrane is provided between said fuel tank and said anode.

8. The fuel cell system according to claim 7, wherein said wicking material is inserted so as not to cover said opening.

9. The fuel cell system according to claim 6, wherein said wicking material is material which allows half or more of the fuel sent to said fuel tank to flow on a surface thereof without being absorbed in the wicking material.

10. The fuel cell system according to claim 1, wherein each of said plurality of fuel cells includes an exhausting portion which exhausts gas produced on said anode to outside.

11. The fuel cell system according to claim 10, wherein each of said plurality of fuel cells includes a sealing member provided on a side of said anode, and
wherein said exhausting portion is an exhausting path formed through said sealing member.

12. The fuel cell system according to claim 10, wherein said sealing member is provided with at least one penetrating hole which penetrates said sealing member in an up-and-down direction,
wherein a member disposed on said sealing member has a hole at a position corresponding to said penetrating hole, and
wherein said exhausting portion allows said anode to communicate with outside through said penetrating hole and said hole.

13. The fuel cell system according to claim 1, wherein each of said plurality of fuel cells includes:
a vaporization suppressing member disposed on said cathode and having a moisturizing property; and
a meshed cover member disposed on said vaporization suppressing member.
